(19) United States
(12) Patent Application Publication
(10) Pub. No.: US 2021/0033116 A1
(43) Pub. Date: Feb. 4, 2021

(54) Magnetic-Hydraulic Pump

(71) Applicant: Hao Xu, SR., Bedford (CA)

(72) Inventor: Hao Xu, SR., Bedford (CA)

(21) Appl. No.: 17/068,440

(22) Filed: Oct. 12, 2020

(51) Int. Cl. F15B 15/02; F04B 9/00; F04B 17/00

(52) U.S. Cl. CPC F15B 15/02; F15B 2211/20507; F04B 17/00; F04B 9/00

(57) ABSTRACT

This Magnetic-hydraulic pump is an appliance that uses magnetic force to pump hydraulic liquid, so as to drive a hydraulic motor as rotating output. In such way, The magnetic force is turned to rotating movement.

In order to continuously gain the turning output, this appliance makes these pumping containers circularly arranged, and could be restored without the liquid backwards.

This Magnetic-hydraulic Pump is an appliance that uses hydraulic as a medium to absorb magnetic force and change the magnetic energy to pressure-liquid so that to drive a hydraulic motor, which can drive various machines including generator.

### 1. BRIEF DESCRIPTION OF THE DRAWINGS

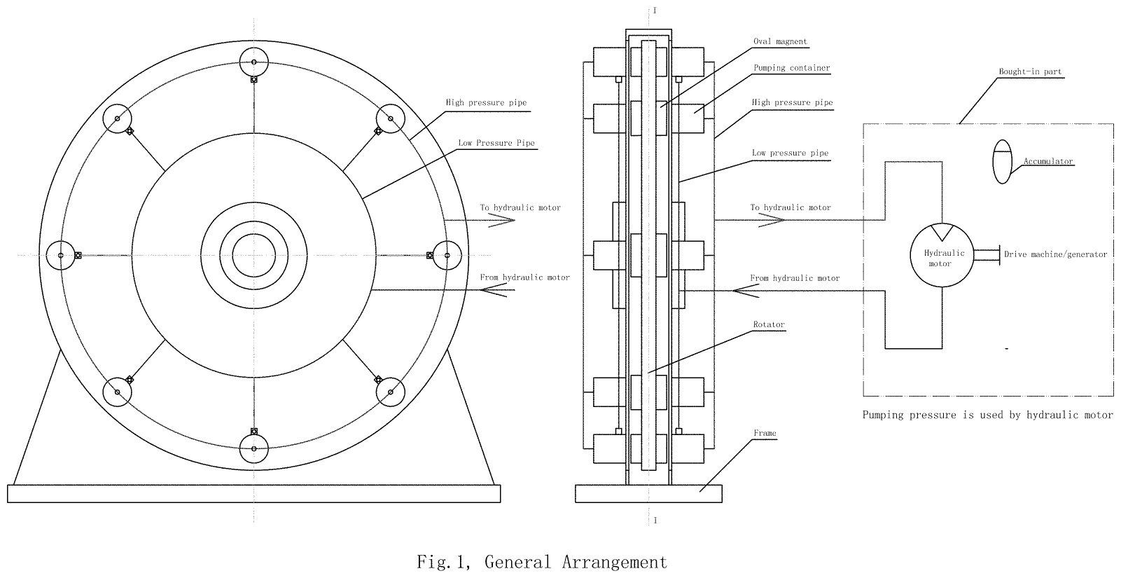

1) FIG. 1, General Arrangement: In this FIG., there are a front view and a left view of the appliance.

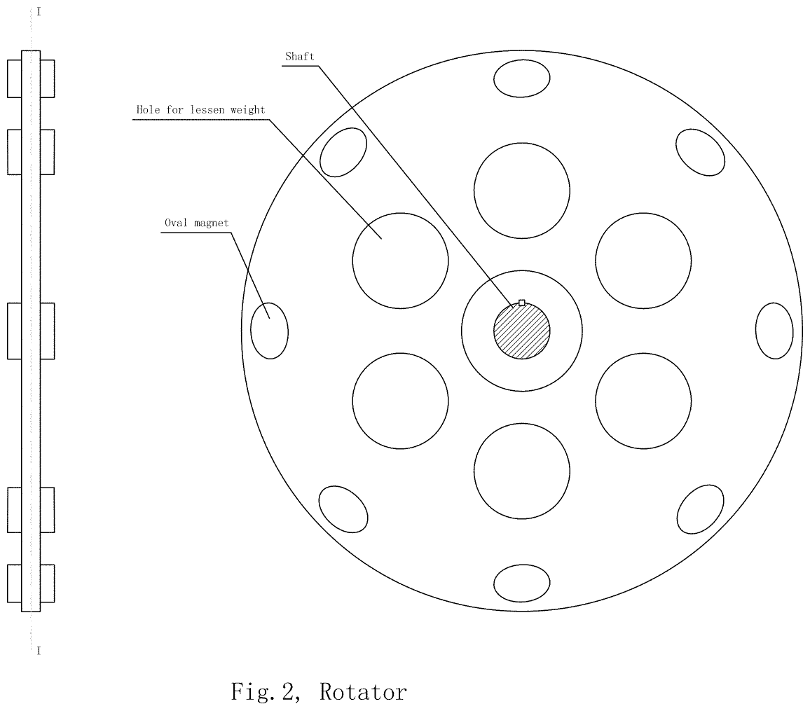

2) FIG. 2, Rotator: In this FIG. , there are a front view and a left view of the rotator.

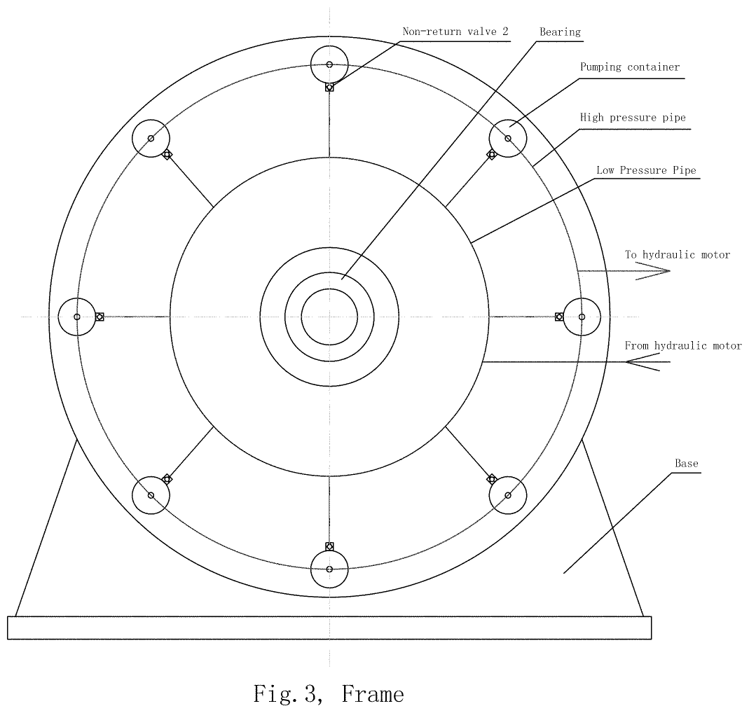

3) FIG. 3, Frame: In this FIG. , there is a front view of the frame.

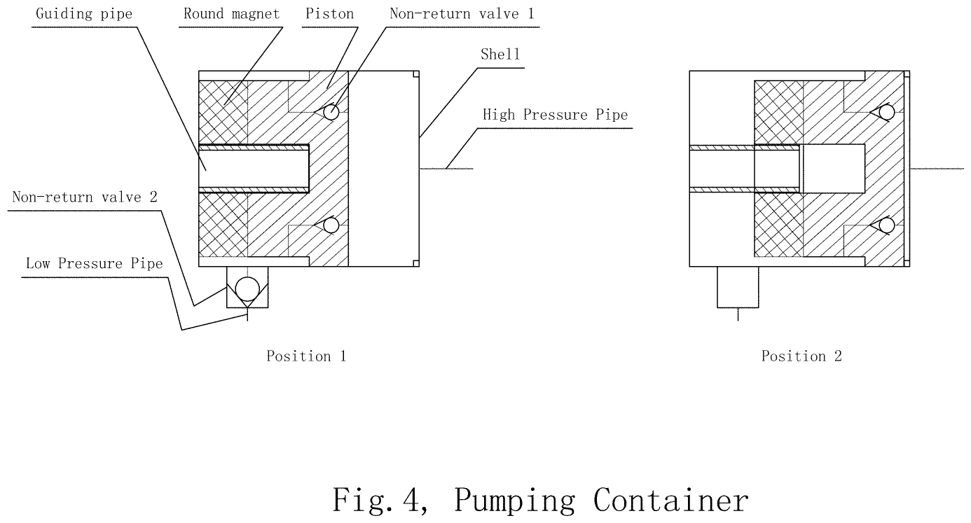

4) FIG. 4, Pumping Container: In this FIG. , there are two cross section views of the pumping container, position 1 and position 2.

### 2. COMPOSITION

This Magnetic-hydraulic Pump is consisted of two parts, rotator and frame, referring to FIG. 1, General Arrangement. Both the rotator and frame are symmetrically arranged to its vertical center line I-I, so that the reacting forces of the magnetic pumping forces are offset on the rotator and vibration to the frame would be reduced greatly. Symmetrical arrangement also makes the appliance works more efficiently.

On the rotator 8 oval permanent magnets are arranged evenly in circular each side, referring FIG. 2, Rotator, and the number of the magnets could be adjudged according to the sizes of the appliance as well as the magnets. Oval profile is to get more time to acting. All poles of the magnets on the rotator are arranged on one direction along the shaft. The shaft is used to turn the rotator.

On the frame the same number of pumping containers is arranged correspondingly to the magnets on the rotator, referring FIG. 3, Frame, and also arranged on the frame are high pressure pipe, low pressure pipe, non-return valve 2, bearings and base.

In each of the pumping container, referring FIG. 4, Pumping Container, arranged are round permanent magnet, piston, non-return valve 1, guiding pipe and shell, etc. The direction of the poles of the magnets in the pumping containers is opposite to those on the rotator, and the round magnets are fixed to the pistons in each container.

### 3. Working Principle

When the shaft is turned by outside power, the oval magnets will be turning around in circle. When the oval magnets turn to the position at the same angle with the pumping containers, a magnetic repulse force occurs between the oval magnets and the round magnets. This force pushes the pistons from Position 1 forward to as far as Position 2, referring FIG. 4, Pumping Container, and the movement of pistons causes the hydraulic pressure, which shuts down non-return valve 1, makes liquid flowing along the high pressure pipe and then drives hydraulic motor turning, with part of the flow to the accumulator in the pipe system. Meanwhile after the hydraulic motor the flow goes by the low pressure pipe to the non-return valve 2, which is opened by the movement of piston, and makes up the place because of the move of the piston.

When the oval magnets turn to the positions between the pumping containers, the magnetic force degrades, while the pressure at the high part would still be kept rather high because of the accumulator, referring Position 2, FIG. 4, Pumping Container, and because the area of the left side of the piston is smaller than that of the right side of the piston, so the pressure on the left side is higher and that makes the non-return valve 1 open and the non-return valve 2 closed, thus the liquid would flow from the left to the right of piston, so the piston get back towards position 1, without causing the flow back lost.

With the continuous turning of the rotator, the pistons in the pumping containers would pump liquid continuously to the hydraulic motor and the hydraulic motor can be used to drive some machine and/or generator as power output.

### 4. Some Explanations

1) Instead of the turning power, it is the magnetic force that press the liquid moving, and the reacting force of that is offset on the rotator, so the turning power for the rotator is only for changing the magnets' position and getting the pistons for their next cycles.

2) The turning power can be from an electric motor, and its electricity can be from the generator driven by the hydraulic motor. The turning of the rotator can also be driven by the hydraulic motor by some type of transmission. Where the turning of the rotator is depended on the hydraulic motor, either by the generator or by transmission, a starter would be arranged like that for a car.

3) During the continuously turning of the rotator, 16 pumping containers in this appliance would provide totally 128 piston strokes separately by 8 times per revolution of 360°. The distances of strokes may change when the output of the hydraulic motor changes, i.e., the distances would be to the upmost when no load on the hydraulic motor, and the distances become shorter when the hydraulic motor gets some load. In this way, as a result, this appliance can adjust the working ability itself.

4) When actual manufactured there would be two or more of this appliance connected on the same one shaft but the magnetic acting is arranged in offset time, one appliance in acting while the other in restore, so that they can keep the pressure rather stable and get a more constant power output.

### 5. Application and Prospect

This appliance provides a way of utilization of magnetic force as one of clean sources of energy to substitute fossil energy. Unlike a fossil-fuel motor, Magnetic-hydraulic Pump does not need air and has nothing to discharge, so no pollution will be co-produced either to the air or land during the energy transforming. Nor like a solar/wind motor, Magnetic-hydraulic Pump produces stable power output without depending on the weather.

Still, it would be a better power source for a moving vessel by saving places for fuels. Also, using this appliance as the battery of an electric vehicle will thoroughly solve the problem of battery charging.

Available data shows that some kinds of magnets have more than 8 years of 80% residue of magnetic strength, which is good enough for most kinds of machines to work normally.

Besides, comparing to a fossil fuel engine, this appliance is more simply structured, less costed for producing and more conveniently maintained during its service life term.

Its future shall be good.

1. Using hydraulic pump to change magnetic power to rotating power.

2. Symmetrically arrangement of rotator and frame so as to offset the reacting force of the magnetic pumping force.

3. Getting piston restored by the pressure difference and valves on its two sides without causing flow back in a magnetic-hydraulic pump.
